(19) United States
(12) Patent Application Publication
(10) Pub. No.: US 2018/0169915 A1
(43) Pub. Date: Jun. 21, 2018

(54) Making Method of Combination of Metal and Plastic with Metal Formed by Aid of High Temperature Gas

(71) Applicants: Chih-Chia Wei, Taichung City (TW); Shih-Ming Hsu, Taichung City (TW)

(72) Inventors: Chih-Chia Wei, Taichung City (TW); Shih-Ming Hsu, Taichung City (TW)

(21) Appl. No.: 15/382,781

(22) Filed: Dec. 19, 2016

(51) Int. Cl. B29C 45/14; B29C 45/00; B29C 65/48; B29C 65/00; B21D 26/021

(52) U.S. Cl. CPC B29C 45/14344; B29C 45/006; B29K 2705/00; B29C 66/742; B21D 26/021; B29C 65/48

(57) ABSTRACT

A making method of combination of metal and plastic includes placing a metal plate into a die, applying a determined pressure on the metal plate, heating the die by a heating device to a determined temperature to soften and deform the metal plate, introducing a high pressure gas to blow and press the metal plate that is softened into a die cavity to form a metallic member formed by aid of a high temperature gas, removing the metallic member, and combining the metallic member with a plastic member.

### BACKGROUND OF THE INVENTION

### 1. Field of the Invention

The present invention relates to a making method and, more particularly, to a making method of combination of metal and plastic applied for a cellphone, a tablet computer, a notebook computer, eyeglasses, a cosmetic box, car ornaments, lamp decorations and the like.

### 2. Description of the Related Art

A conventional cellphone comprises a metallic shell (made of aluminum alloy) and a plastic member combined with the metallic shell. In a first method of combination of the metallic shell and the plastic member, the metallic shell is initially worked by the CNC working procedure to form a plurality of slots, and is then treated by the anodizing process. However, the working process is complicated, thereby increasing the cost of fabrication. In addition, the working blade is easily worn out during a period of time, thereby decreasing the working precision, and thereby decreasing the quality of the product. Further, the chemical agents will erode the metallic material and the plastic material after the anodizing process is finished. After the working process is finished, the plastic material is formed on the metallic shell by an injection molding process. However, the metallic shell is not fully planar and includes some arcuate portions and some stripes so that the plastic material flows randomly and is easily spilled. In addition, the plastic material easily protrudes outward from the slots of the metallic shell, thereby decreasing the aesthetic quality of the metallic shell, and easily causing an uncomfortable sensation to the user when touching the metallic shell. In a second method of combination of the metallic shell and the plastic member, the metallic shell and the plastic member are combined by adhesive. However, the metallic shell and the plastic member are made of different material so that the metallic shell and the plastic member are not bonded together closely and tightly.

A conventional modern product, such as a tablet computer, a notebook computer, eyeglasses, a cosmetic box, a car ornament, a lamp decoration and the like, also comprises a metallic member and a plastic member which are combined together. In fabrication, the metallic member is made of aluminum and is formed by an extruding process or a stamping process. Then, the plastic member is stuck to the metallic member so that the metallic member and the plastic member are combined integrally. After the metallic member is formed, the metallic member needs a further working procedure, such as the hair-line surface treatment, sand blasting, polishing or abrading, to form complicated stripes, reliefs or totems on the outer face of the metallic member. However, the outer face of the metallic member presents a mirror effect of different roughness or presents different stripes, reliefs or totems after multiple complicated working procedures, thereby prolonging the working time, wasting the labor work and increasing the cost of fabrication. In addition, the working blade is easily worn out during a period of time, thereby decreasing the working precision, and thereby decreasing the quality of the product.

### BRIEF SUMMARY OF THE INVENTION

The primary objective of the present invention is to provide a making method of combination of metal and plastic with the metal being formed by aid of a high temperature gas.

In accordance with the present invention, there is provided a making method of combination of metal and plastic, comprising placing a metal plate into a die, applying a determined pressure on the metal plate, heating the die by a heating device to a determined temperature to soften and deform the metal plate, introducing a high pressure gas to blow and press the metal plate that is softened into a die cavity to form a metallic member formed by aid of a high temperature gas, removing the metallic member, and combining the metallic member with a plastic member.

According to the primary advantage of the present invention, the metallic member reproduces the complicated stripes, reliefs or totems of the die cavity of the die during the molding process, so that the outer face of the metallic member has diverse variations and presents different appearance, thereby enhancing the aesthetic quality of the metallic member.

According to another advantage of the present invention, the outer face of the metallic member is directly molded and shaped, without needing a further working procedure, such as the hair-line surface treatment, sand blasting, polishing or abrading, thereby decreasing the cost of fabrication, enhancing the working precision, and increasing the quality of the product.

According to a further advantage of the present invention, the metallic member is made without needing a further working procedure, thereby decreasing the working time and saving the labor work.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view showing combination of a metallic member and a plastic member in accordance with a first preferred embodiment of the present invention.

FIG. 2 is a cross-sectional view showing combination of a metallic member and a plastic member in accordance with a second preferred embodiment of the present invention.

FIG. 3 is a cross-sectional view showing combination of a metallic member and a plastic member in accordance with a third preferred embodiment of the present invention.

FIG. 4 is a cross-sectional view showing combination of a metallic member and a plastic member in accordance with a fourth preferred embodiment of the present invention.

FIG. 5 is a cross-sectional view showing combination of a metallic member and a plastic member in accordance with a fifth preferred embodiment of the present invention.

FIG. 6 is a cross-sectional view showing combination of a metallic member and a plastic member in accordance with a sixth preferred embodiment of the present invention.

FIG. 7 is a cross-sectional view showing combination of a metallic member and a plastic member in accordance with a seventh preferred embodiment of the present invention.

### DETAILED DESCRIPTION OF THE INVENTION

A making method of combination of metal and plastic in accordance with the present invention comprises placing a metal plate into a die, applying a determined pressure on the metal plate, heating the die by a heating device to a determined temperature to soften and deform the metal plate, introducing a high pressure gas to blow and press the metal plate that is softened into a die cavity to form a metallic member formed by aid of a high temperature gas, removing the metallic member, and combining the metallic member with a plastic member.

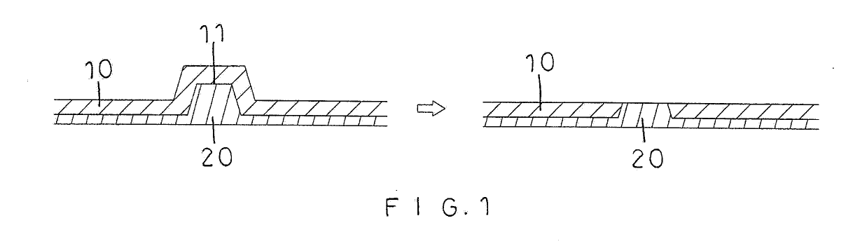

Referring to the drawings and initially to FIG. 1, the step of combining the metallic member with a plastic member has a filling manner and includes: forming an outward or inward protruding recessed portion 11 on the metallic member 10, injection molding a plastic member 20 in the recessed portion 11 by a plastic filling die (not shown), and cutting residual metallic material and plastic material in the recessed portion 11, which protrude from and exceed the thickness of the metallic member 10, so that the metallic member 10 and the plastic member 20 are combined integrally. The recessed portion 11 has a depth greater than the thickness of the metallic member 10. Preferably, the recessed portion 11 has different shapes and sizes.

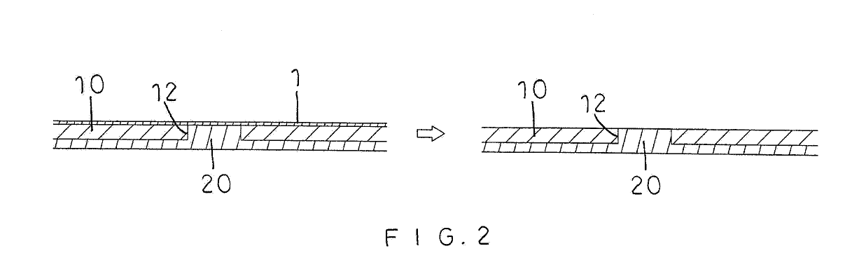

Referring to FIG. 2, the step of combining the metallic member with a plastic member has a filling manner and includes: forming a through hole 12 in the metallic member 10, covering and attaching a film 1 on an outer face of the metallic member 10, injection molding a plastic member 20 in the through hole 12 by a plastic filling die (not shown), and removing the film 1, so that the metallic member 10 and the plastic member 20 are combined integrally. Preferably, the through hole 12 has different shapes and sizes.

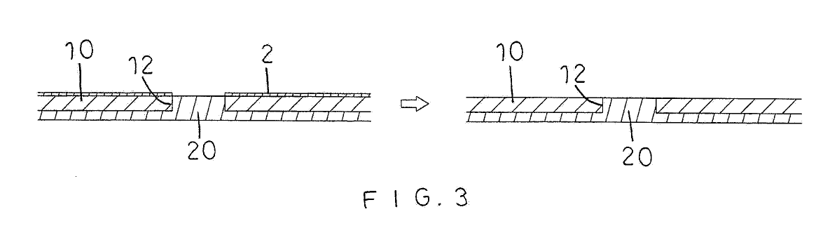

Referring to FIG. 3, the step of combining the metallic member with a plastic member has a filling manner and includes: forming a through hole 12 in the metallic member 10, printing or coating a protective layer 2 on an outer face of the metallic member 10, injection molding a plastic member 20 in the through hole 12 by a plastic filling die (not shown), and removing the protective layer 2, so that the metallic member 10 and the plastic member 20 are combined integrally. Preferably, the through hole 12 has different shapes and sizes.

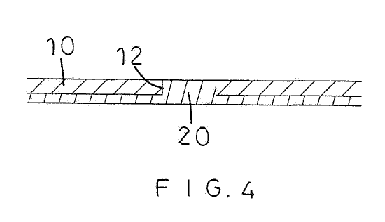

Referring to FIG. 4, the step of combining the metallic member with a plastic member has a filling manner and includes: forming a through hole 12 in the metallic member 10, and directly injection molding a plastic member 20 in the through hole 12 by a plastic filling die (not shown), so that the metallic member 10 and the plastic member 20 are combined integrally. Preferably, the through hole 12 has different shapes and sizes.

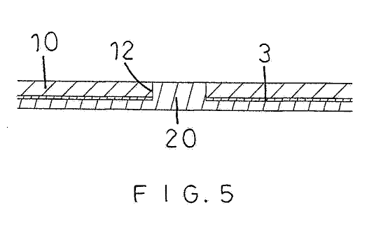

The step of combining the metallic member with a plastic member has a sticking manner and includes: injection molding a plastic member 20 by a plastic filling die (not shown), sticking, spraying or coating a layer of glue 3 (see FIG. 5) on the metallic member 10, and sticking the plastic member 20 to the metallic member 10, so that the metallic member 10 and the plastic member 20 are combined integrally. Preferably, the glue 3 is a double-sided adhesive or a liquid glue.

Referring to FIG. 5, the step of combining the metallic member with a plastic member has a sticking manner and includes: forming a through hole 12 in the metallic member 10, injection molding a plastic member 20 by a plastic filling die (not shown), with the plastic member 20 being insertable into the through hole 12, sticking, spraying or coating a layer of glue 3 on a periphery of the through hole 12, and sticking the plastic member 20 to the metallic member 10, so that the metallic member 10 and the plastic member 20 are combined integrally. Preferably, the through hole 12 has different shapes and sizes. Preferably, the glue 3 is a double-sided adhesive or a liquid glue.

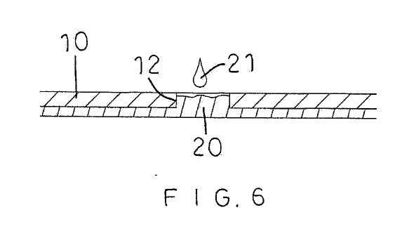

Referring to FIG. 6, the step of combining the metallic member with a plastic member has a spotting manner and includes: forming a through hole 12 in the metallic member 10, injection molding a plastic member 20 by a plastic filling die (not shown), and spotting a plastic material 21 which is disposed at a fused state into the through hole 12, so that the metallic member 10 and the plastic member 20 are combined integrally after the plastic material 21 is solidified. Preferably, the through hole 12 has different shapes and sizes. In addition, the plastic material 21 and the plastic member 20 are made of the same material.

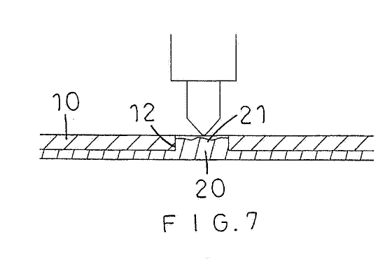

Referring to FIG. 7, the step of combining the metallic member with a plastic member has a pouring manner and includes: forming a through hole 12 in the metallic member 10, injection molding a plastic member 20 by a plastic filling die (not shown), and pouring a plastic material 21 which is disposed at a fused state into the through hole 12, so that the metallic member 10 and the plastic member 20 are combined integrally after the plastic material 21 is solidified. Preferably, the through hole 12 has different shapes and sizes. In addition, the plastic material 21 and the plastic member 20 are made of the same material.

In conclusion, when the metallic member 10 is formed by aid of a high temperature gas, the outer face of the metallic member 10 reproduces the different and complicated stripes, reliefs or totems of the die cavity of the die and presents a mirror effect of different roughness during the molding process, without needing a working procedure, such as the hair-line surface treatment, sand blasting, polishing or abrading. Then, the metallic member 10 and the plastic member 20 are combined integrally. Preferably, the metallic member 10 and the plastic member 20 are combined integrally by sticking (double-sided adhesive or liquid glue) or by pressure or temperature (hot-press gluing). Alternatively, the metallic member 10 is planted in a plastic filling die, and plastic material is filled into the plastic filling die, so that the metallic member 10 and the plastic member 20 are combined integrally. Alternatively, fused plastic material is filled or dripping into the determined position so that the metallic member 10 and the plastic member 20 are combined integrally.

Accordingly, the metallic member 10 reproduces the complicated stripes, reliefs or totems of the die cavity of the die during the molding process, so that the outer face of the metallic member 10 has diverse variations and presents different appearance, thereby enhancing the aesthetic quality of the metallic member 10. In addition, the outer face of the metallic member 10 is directly molded and shaped, without needing a further working procedure, such as the hair-line surface treatment, sand blasting, polishing or abrading, thereby decreasing the cost of fabrication, enhancing the working precision, and increasing the quality of the product. Further, the metallic member 10 is made without needing a further working procedure, thereby decreasing the working time and saving the labor work.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A making method of combination of metal and plastic, comprising:
placing a metal plate into a die, applying a determined pressure on the metal plate;
heating the die by a heating device to a determined temperature to soften and deform the metal plate;
introducing a high pressure gas to blow and press the metal plate that is softened into a die cavity to form a metallic member formed by aid of a high temperature gas;
removing the metallic member; and
combining the metallic member with a plastic member.

2. The making method of combination of metal and plastic of claim 1, wherein the step of combining the metallic member with a plastic member includes:
forming an outward or inward protruding recessed portion on the metallic member;
the recessed portion having a depth greater than a thickness of the metallic member;
injection molding a plastic member in the recessed portion by a plastic filling die; and
cutting residual metallic material and plastic material in the recessed portion, which protrude from and exceed the thickness of the metallic member, so that the metallic member and the plastic member are combined integrally.

3. The making method of combination of metal and plastic of claim 1, wherein the step of combining the metallic member with a plastic member includes:
forming a through hole in the metallic member;
covering and attaching a film on an outer face of the metallic member;
injection molding a plastic member in the through hole by a plastic filling die; and
removing the film, so that the metallic member and the plastic member are combined integrally.

4. The making method of combination of metal and plastic of claim 1, wherein the step of combining the metallic member with a plastic member includes:
forming a through hole in the metallic member;
printing or coating a protective layer on an outer face of the metallic member;
injection molding a plastic member in the through hole by a plastic filling die; and
removing the protective layer, so that the metallic member and the plastic member are combined integrally.

5. The making method of combination of metal and plastic of claim 1, wherein the step of combining the metallic member with a plastic member includes:
forming a through hole in the metallic member; and
directly injection molding a plastic member in the through hole by a plastic filling die, so that the metallic member and the plastic member are combined integrally.

6. The making method of combination of metal and plastic of claim 1, wherein the step of combining the metallic member with a plastic member includes:
injection molding a plastic member by a plastic filling die;
sticking, spraying or coating a layer of glue on the metallic member; and
sticking the plastic member to the metallic member, so that the metallic member and the plastic member are combined integrally.

7. The making method of combination of metal and plastic of claim 6, wherein the glue is a double-sided adhesive or a liquid glue.

8. The making method of combination of metal and plastic of claim 1, wherein the step of combining the metallic member with a plastic member includes:
forming a through hole in the metallic member;
injection molding a plastic member by a plastic filling die, with the plastic member being insertable into the through hole;
sticking, spraying or coating a layer of glue on a periphery of the through hole; and
sticking the plastic member to the metallic member, so that the metallic member and the plastic member are combined integrally.

9. The making method of combination of metal and plastic of claim 8, wherein the glue is a double-sided adhesive or a liquid glue.

10. The making method of combination of metal and plastic of claim 1, wherein the step of combining the metallic member with a plastic member includes:
forming a through hole in the metallic member;
injection molding a plastic member by a plastic filling die; and
spotting a plastic material which is disposed at a fused state into the through hole, so that the metallic member and the plastic member are combined integrally after the plastic material is solidified; and
the plastic material and the plastic member are made of the same material.

11. The making method of combination of metal and plastic of claim 1, wherein the step of combining the metallic member with a plastic member includes:
forming a through hole in the metallic member;
injection molding a plastic member by a plastic filling die; and
pouring a plastic material which is disposed at a fused state into the through hole, so that the metallic member and the plastic member are combined integrally after the plastic material is solidified; and
the plastic material and the plastic member are made of the same material.
